(19) United States
(12) Patent Application Publication
(10) Pub. No.: US 2008/0148340 A1
(43) Pub. Date: Jun. 19, 2008

(54) METHOD AND SYSTEM FOR PROVIDING NETWORK ENFORCED ACCESS CONTROL

(75) Inventors: Carl Marshall Eliot Powell, Gaithersburg, MD (US); John-Francis Mergen, Baltimore, MD (US)

Correspondence Address: VERIZON;PATENT MANAGEMENT GROUP, 1515 N. COURTHOUSE ROAD, SUITE 500, ARLINGTON, VA, 22201-2909, US

(73) Assignee: MCI, LLC., Basking Ridge, NJ (US)

(21) Appl. No.: 11/554,881

(22) Filed: Oct. 31, 2006

(51) Int. Cl. H04L 9/00; G06F 15/173

(52) U.S. Cl. 726/1; 709/225

(57) ABSTRACT

An approach is provided for controlling access to network resources. A metric (e.g. a voucher) is received corresponding to a policy for accessing a resource within a network. Rating of a user is updated based on the received metric. An access level is granted for accessing the resource to the user based on the rating.

### BACKGROUND INFORMATION

Most organizations have a need to control network access to implement security policies that protect the organizations' network resources. Towards this end, different tools have been developed and applied to different parts of a policy. In many cases, the policy is enforced administratively rather than based on strict technological solutions. As an example, a typical environment might deploy a firewall to implement role-based access to server resources, and a virus scanning system that remotely initiates scans and downloads definition files. Also, such a deployment might utilize an update server for notifying the user when updates are available to be installed. However, none of these systems interacts with each other; and the degree of enforcement these solutions provide can be highly variable. The firewall, for example, may always require authentication, while the update server relies on an action by the user to implement critical updates. This lack of integration and consistent enforcement between systems create unexpected vulnerabilities in the network. One such vulnerable situation can involve, for example, a user being permitted to access a critical server because the authentication was performed correctly; however, because a security patch had not been applied, the operation system is compromised by a virus—e.g., Trojan Horse.

Additionally, traditional systems vary widely in their degree of flexibility. Policies typically must be enforced on an “all-or-nothing” basis, requiring all systems to be treated identically.

Therefore, there is a need for an approach to effectively enforce network access policies.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of a communication system utilizing an access policy enforcement system, according to an embodiment of the present invention;

FIG. 2 is a flowchart of a process for dynamically configuring network devices in the system of FIG. 1, according to an embodiment of the present invention;

FIG. 3 is a diagram of an access policy enforcement system, according to an embodiment of the present invention;

FIG. 4 is a flowchart of a process for granting access to network resources based on user rating, according to an embodiment of the present invention;

FIG. 5 is a diagram showing the multi-level hierarchies supported by the system of FIG. 1, according to an embodiment of the present invention;

FIG. 6 is a diagram of an exemplary voucher-based system for providing remote access, according to an embodiment of the present invention;

FIG. 7 is a flowchart of the remote operation process of the system of FIG. 6, according to an embodiment of the present invention; and

FIG. 8 is a diagram of a computer system that can be used to implement various embodiments of the present invention.

### DETAILED DESCRIPTION

An apparatus, method, and software for providing network enforced access control are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

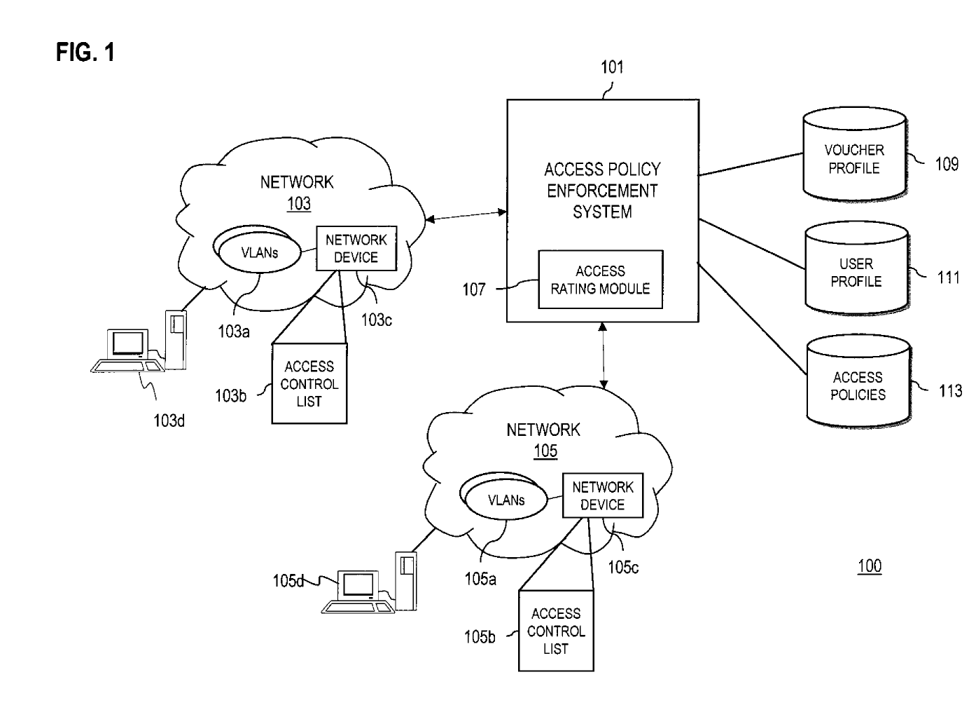

FIG. 1 is a diagram of a communication system utilizing an access policy enforcement system, according to an embodiment of the present invention. A communication system 100 includes an access policy enforcement system 101 for ensuring that access policies of data networks 103, 105 are monitored and policed. By way of example, the access policy enforcement system 101 utilizes an access rating module 107 to rate users or systems based on compliance with policies. As shown, the access policy enforcement system 101 includes a voucher profile database 109 for storing vouchers that are reported by applications within the networks 103, 105. A user profile database 111 is also maintained to capture information about the users. The system 101 further maintains a database 1 13 for storing access policies that are to be implemented within the networks 103, 105.

noted, enforcement of such policies has traditionally been haphazard and lacking in terms of integration, thereby exposing the system to certain vulnerabilities. One concern is the fact that enforcement of policy can vary greatly depending on the tool used to implement the policy. For example, authentication tools typically provide strong enforcement by blocking access, if the authentication is not successful, but other tools can be blocked or are even at the option of the user. Forced updates and remotely triggered scans provide some level of enforcement, but only if the host (i.e., computing system or device) is directly under the aegis of network managers. Many networks include network devices that bypass network security “requirements.”

Another undesirable property is that the levels of access are tied only to authentication. This can occur either through an all-or-nothing authentication at connection time, by using an authentication client to open a firewall/Virtual Private Network (VPN), by having the authentication performed by each application, or (most commonly) a combination of these techniques. Using only authentication mechanisms create unexpected vulnerabilities in that a user may have the authority to act in a role, even though the workstation does not have sufficient assurance for that role. That is, the user has the authentication password to gain access, but the computer has been compromised because of a missing security update. There is the secondary problem of the different levels of access requiring additional user action, which can seriously impact response time, particularly in a crisis situation.

Also, traditional approaches do not provide a way for an endpoint to view a requestor's complete security profile. Namely, pieces of the profile are maintained across a variety of systems that are not designed to share that information. This reality makes the task of obtaining a more complete picture of a requestor's level of assurance impractical.

Another consequence of poor integration is that a malware threat (e.g., viruses or Internet worms) across an enterprise cannot be effectively dealt with without implementing drastic, costly security measures. Such threat is particularly problematic when a remedy is not yet available. To combat this threat, one traditional approach has been to shut down the transmission vectors for the threat (e.g., blocking email or certain types of attachments) until all of the computers in the organization have been inoculated. Such measure can involve blocking those systems that would not be affected, because of the lack of fine-grain control in the access system. While this is effective, it essentially acts as a Denial of Service (DoS) attack against the portions of the organization's infrastructure that is already safe. Blocking access or requiring slow and expensive manual intervention to transfer needed information can cost the organization more than the original malware infection would have. Moreover, even in the case where a remedy is available, it is often difficult to ensure that every computing device has been inoculated. Invariably, there are systems that were offline when the inoculation took place or are not directly under network control.

Another concern is that there is no way to share security profiles with other organizations. As intranets, coalition and partner networks continue to expand, the potential for pathogens to be introduced by computing devices from other security domains increases. Unless every partner network is operating at exactly the same system high assurance level, an organization that receives a partner request may have to choose between allowing information to be released in a way that violates policy or blocking partner access.

It is further recognized that traditional systems do not implement policies that require a tool to use state information that is outside of that particular tool's domain. For example, a reasonable policy for network “A” might require that a station complete a full virus scan before it returns to network A, if the station was previously connected to network “B.” Even though the information necessary to implement this policy may be available, the virus scanning tool is not capable of requesting such information.

As another concern, traditional tools do not provide support for the concepts of system state, age of information or state verification within security policy enforcement. For instance, if a virus scan is not performed periodically, then access to a network resource, such as a mail system, can be denied until a scan is completed. It also becomes difficult to identify the complete policy profile for users, since portions of the profile are typically distributed among different applications and systems. This in turn can lead to bad decisions and “grandfathered” access that should no longer be allowed.

Yet another vulnerability is that fact that changes to policies require considerable effort to translate into the different languages used by the different enforcement tools. This is expensive and can lower the overall security profile by putting backpressure against needed change.

In view of the above recognized vulnerabilities, the access policy enforcement system 101, according to certain embodiments, provides a network-enforced access control mechanism that is driven by policy and “vouchers.” The system 101 is an automatic, scalable system that can maintain dynamic system configuration information, dynamically change access permissions based on threat level or other policy changes, and facilitate the interaction of peer organizations with strong evidence of system configuration assurance. In an exemplary embodiment, the system 101 ties commercially available assurance tools with an enforcement mechanism that is based on extant network infrastructure.

As shown in FIG. 1, the network 103 can utilize segregation facilities, such as Virtual Local Area Network (VLANs) 103a and Access Control Lists (ACLs) 103b managed by a network device 103c (e.g., router, hub, switch, etc.), to control access by a computing device 103d. Similarly, the network 105 can implement VLANs 105a and ACLs 105b through a network device 105c for controlling a computing device (e.g., host, computer, laptop, workstation, etc.) 105d. These network devices 103c and 105c can be configured by the access policy enforcement system 101, as next explained.

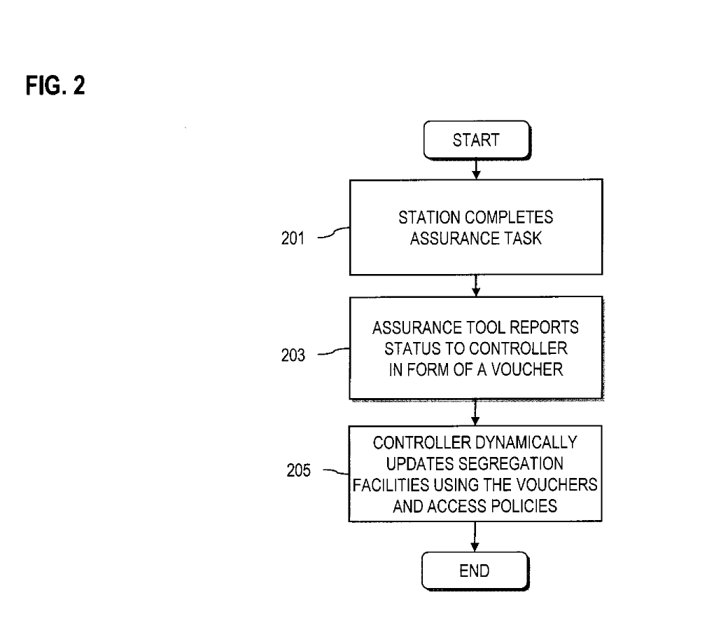

FIG. 2 is a flowchart of a process for dynamically configuring network devices in the system of FIG. 1, according to an embodiment of the present invention. In step 201, each time a computing device (e.g., computing device 103d, 105d) completes an assurance task, such as authenticating or completing a virus scan, an appropriate assurance tool reports the completion to a control infrastructure as a “voucher,” as in step 203. The system 101, as the control infrastructure, uses the vouchers to define policies for determining how to dynamically update the segregation facilities (e.g., Access Control Lists 103b, 105b or VLANS 103a, 105a) by configured the appropriate network device 105c, provided the access policy specifies that level of assurance, per step 205. By maintaining a working set of these assurance vouchers and having the enforcement of policy be network-based, the access policy enforcement system 101 overcomes many of the drawbacks of traditional access control mechanisms. These dynamic control mechanisms permit the access policy enforcement system 301 to provide flexible and fine-grained access control for the network.

Lack of flexibility can negatively impact organizational performance, as extra security mechanisms may be required for all computing systems even though only a small number of systems actually require them. This also entails assuming unnecessary cost. In addition to the direct cost of obtaining additional licenses, there is the indirect cost associated with not being able to easily implement non-standard configurations. For example, a visitor from a partner organization might require Internet access to quickly verify an order or request a quote. Even though it may be more secure, the computer would almost certainly not support the exact list of implementations used by the host organization. Supporting their connectivity would require either an expensive manual effort to create a “safe” network port for them to use, dropping the policy enforcement and allowing an uncontrolled computer on the internal network, or incurring loss to business operations that additional delay would impose. Given that the users (e.g., network administrators) deciding which of these options to implement are frequently not the ones responsible for security or policy enforcement, it is common for an uncontrolled computer to be allowed access to the network with all of the problem associated with that computer.

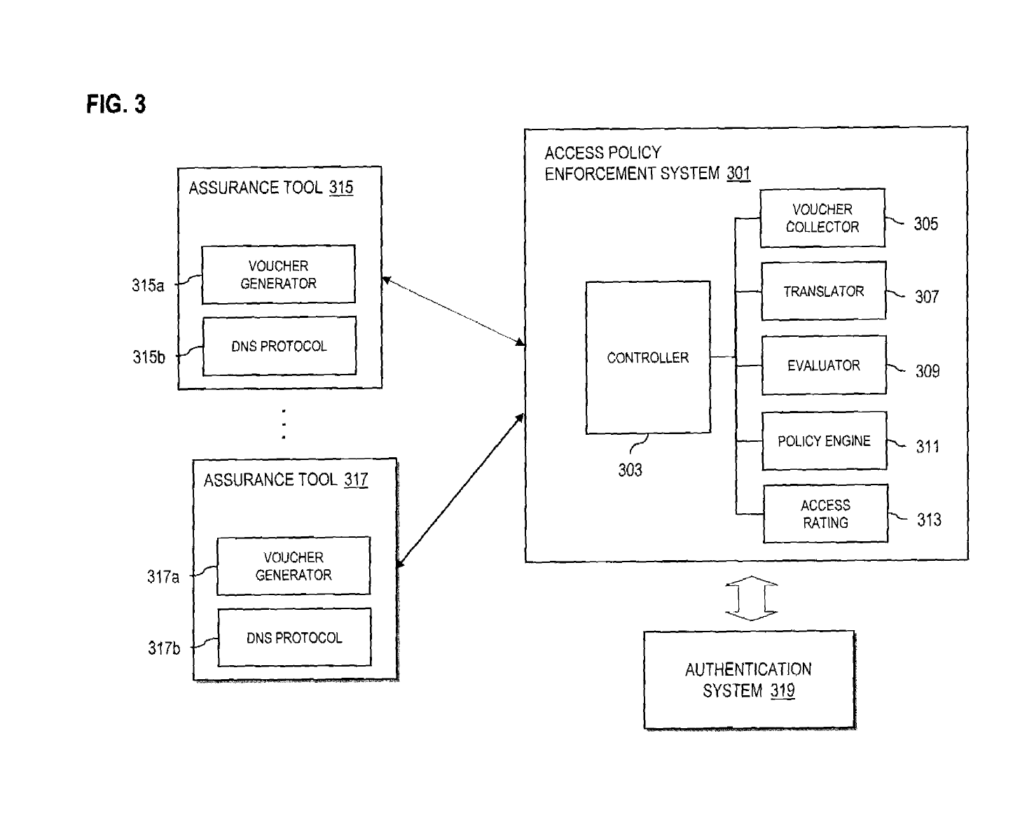

FIG. 3 is a diagram of an access policy enforcement system, according to an embodiment of the present invention. By way of example, an access policy enforcement system 301 includes a controller 303, a voucher collector 305, a translator 307, an evaluator 309, a policy engine 311 and an access rating module 313. The controller 303 communicates with one or more assurance tools 315, 317 to automatically correlate the proof of compliance with policy requirements to levels of network access. The assurance tools 315, 317 each includes a voucher generator 315a, 317a for generating a voucher capturing information (e.g., metric) about a measured activity. In an exemplary embodiment, generation of vouchers is automatic and can be based on measured activities associated with connecting computing devices (e.g., hosts, computers, laptops, workstations, etc.). The voucher can be forwarded to the controller 303 via a Domain Name System (DNS) protocol 315b, 317b, in accordance with one embodiment of the present invention. The system 301 is thus capable of coupling the control of network resources with the testing of the multiple levels of requirements.

With respect to voucher generation, it is recognized that the format of a voucher, designing a method of transfer and providing a real-time archive for the vouchers can be independently developed and customized for each of the assurance tools 315, 317. The system 301 defines equivalence functions for different vouchers, which would permit vouchers from different tools to be compared. This capability is useful in sharing vouchers between organizations that do not utilize identical assurance tool infrastructures.

Traditionally, no method of sharing information about policy definition or enforcement outside of a host's organization exists. In an environment where partner intranets and mobile devices moving between networks are becoming the norm, trying to rationalize the policies in use and their level of enforcement is practically impossible.

To implement the policy engine 311, a policy definition language (e.g., WS-SecurityPolicy) is selected. The evaluator 309 is created for that selected language. The policy language can specify how the network is to respond (in terms of access) to the current set of vouchers for each station (not shown). The evaluator 309 is responsible for comparing the current set of vouchers with the policies to generate the set of access permissions that the system 301 should enforce.

Once a set of access permissions has been determined, they can be implemented in the network. The dynamic update function of the access policy enforcement system 301 provides a translation mechanism, via the translator 307, from the actions specified by policy to the specific control commands needed for network elements and services. In some cases, this entails translating the permissions to a set of rules in a particular device, but more complex scenarios involving the coordinated updating of several different systems are also accommodated. In order to support scaling and rapid response, the update portions of the system 101 can be located with the network devices at the edge of the network.

According to one embodiment of the present invention, a standard communication protocol can be used to export the system voucher information. One exemplary protocol is the Domain Name System (DNS) protocol. As an example, the Host Information (HINFO) record could be used to transfer a signed set of vouchers for a given station, or a new type of query could be developed to provide the same information. However, it is contemplated that a special-purpose mechanism can be created to transport the vouchers to the system 301. Additional integration between the access policy enforcement system 301 system and network infrastructure services, such as DNS and Dynamic Host Configuration Protocol (DHCP), enables a seamless user experience with an unprecedented view into the network portion of the system security profile.

As shown, the access policy enforcement system 301 can interoperate with an authentication system 319.

The access policy enforcement system 301 permits decoupling of the enforcement of policy with the tools 315, 317 to verify that policy, enforcement can be uniform and consistent. Also, because the tools 315, 317 need not provide the only enforcement, access can be tied to any combination of elements that the assurance tools 315, 317 can measure. The working set of vouchers as collected by the voucher collector 305 provides a consistent, current and accessible picture of the assurance state for the host (e.g., host 103d and 105d). In an exemplary embodiment, the assurance vouchers can be stored in a compact, easy-to-interpret format that would make them straightforward to transfer between organizations.

Also, the flexibility of this enforcement mechanism allows a more tailored response to a malware incident, which can provide a much greater level of operational continuity. The consistent enforcement, on the other hand, prevents systems from “slipping through the cracks.”

The policy engine 311 can have access to all of the inputs from all of the assurance tools 315, 317, wherein a policy could make use of any of the pieces of information available to any of the tools. The compact nature of the vouchers allows them to be easily archived for future use. This allows policies to look across more than just the current session in evaluating the level of access to be granted. Also, the policy engine 311 implements the policy results directly, and can automatically implement changes in policy, for example, by pushing new information to each of the tools 315, 317.

Moreover, the access policy enforcement system 301, according to certain embodiments, can provide a number of benefits. For instance, by using failsafe policies to limit access to approved devices and forcing voucher generation (e.g., through network logon), the system 301 can create an automatically updated dynamic list of the entities on the network. The list can then be used for a variety of tasks, ranging from verifying network usage to determining a risk mitigation strategy for a sudden malware outbreak.

Also, the system 301 can support the use of a “threat level” voucher that is not tied to any given host or system, thereby allowing the implementation of a Risk Adaptive Access Control (RADAC) mechanism. Unlike tools that grant or reject access only at one point in time (e.g., at network logon), the access policy enforcement system 301 has the capability of changing the level of network access permitted at any time.

Further, by concentrating the access control at the edges of the network, the access policy enforcement system 301 can scale as the network does.

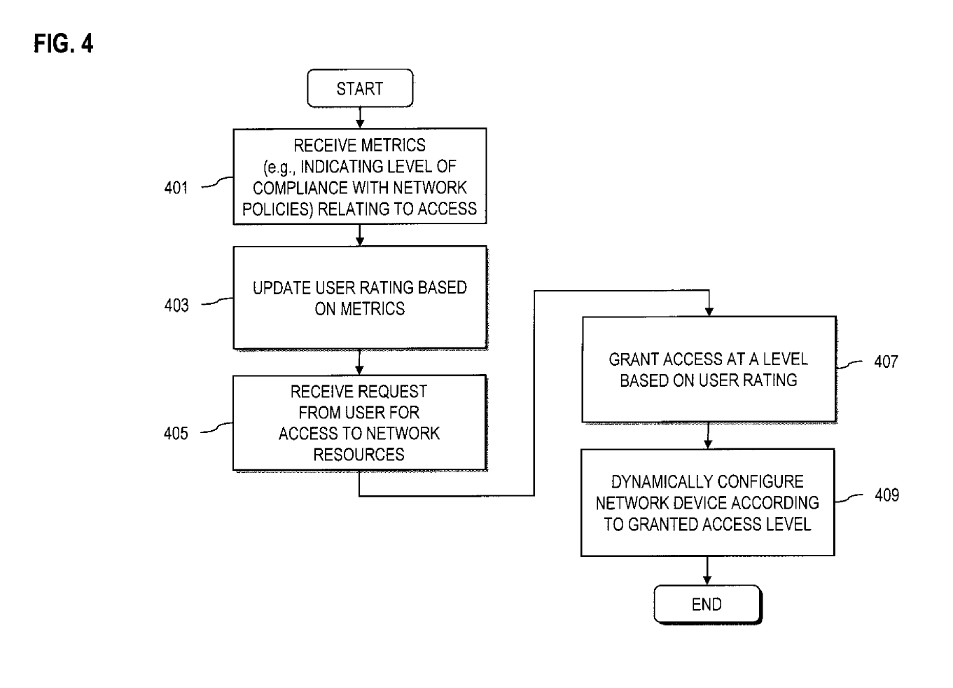

FIG. 4 is a flowchart of a process for granting access to network resources based on user rating, according to an embodiment of the present invention. For the purposes of illustration, this process is explained with respect to the system of FIG. 3. In step 401, the access policy enforcement system 301 receives metrics (as represented by a voucher, for example) relating to access to a network resource. The system 301 then updates a user rating based on the received metrics, per step 403. At this point, the system 301 receives an access request from a user, as in step 405. In response to the request, the system 301 grants, per step 407, an access level that is based on the determined user rating. Thereafter, the system 301 dynamically configures one or more network devices according to the granted access level (step 409).

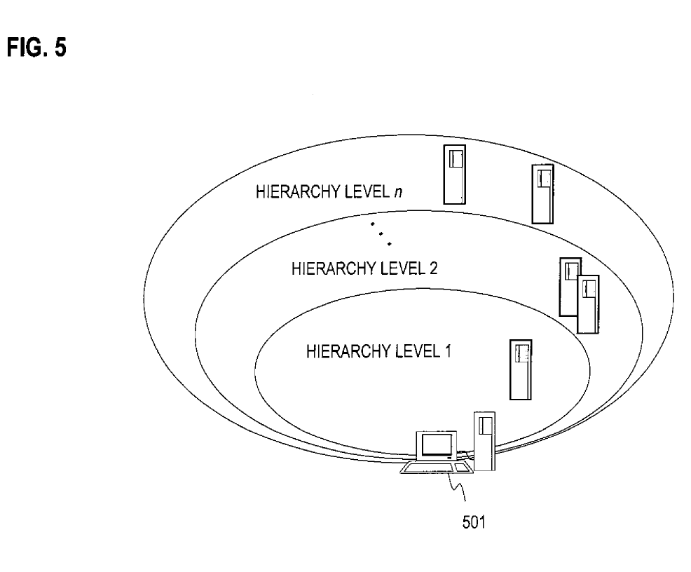

FIG. 5 is a diagram showing the multi-level hierarchies supported by the system of FIG. 1, according to an embodiment of the present invention. The access policy enforcement system 301, in an exemplary embodiment, can support multiple hierarchies simultaneously. Each hierarchy level (e.g., level 1 to level n) can be associated with its own set of policies that specify when access to network resources can be granted. Also, policies can be implemented that allow a given host or client 501 to have simultaneous access to two or more hierarchies.

Accordingly, the access policy enforcement system 101 automatically manages and controls multiple levels of access to a data network. As described, varying levels of access are granted to a host 103d or computer when the host 103d completes a policy-defined task (such as performing a virus scan or authenticating the user), with the degree of access being automatically enforced by the network infrastructure.

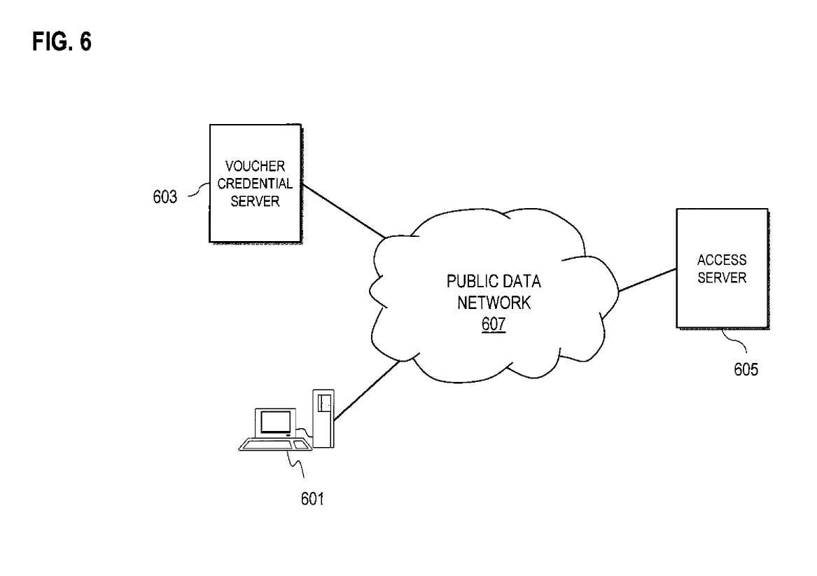

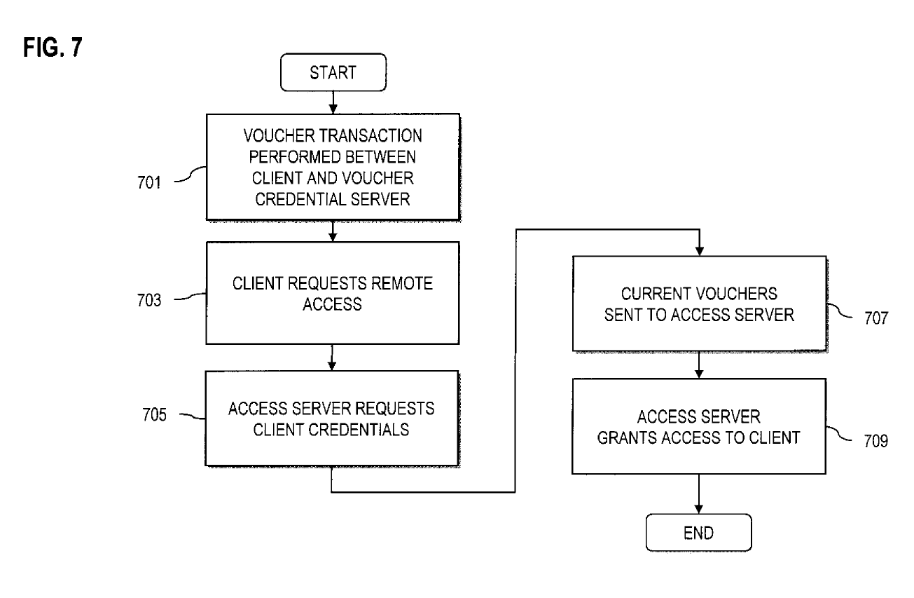

FIG. 6 is a diagram of an exemplary voucher-based system for providing remote access, according to an embodiment of the present invention. In this example, a host or client 601 can communicate with a voucher credential server 603 and an access server 605 to be permitted access to a public data network 607. This interaction is explained in FIG. 7.

FIG. 7 is a flowchart of the remote operation process of the system of FIG. 6, according to an embodiment of the present invention. When the client 601 first enters the network 607, the client 601 carries on a set of voucher transactions, as in step 701, with a local network system, which includes the voucher credential server 603 and the host 601. These vouchers are maintained by the credential server 603. Subsequently, in step 703, the client 601 attempts to remotely access a service. The access server 605 then requests the client credentials from the voucher credential server 603, per step 705. That is, the remote service queries the voucher credential server 603 for the client's current voucher set to ensure that the client's security posture matches that required by the policy of the remote access server 605. In step 707, the current vouchers are transmitted to the access server 605. Thereafter, the access server 605 grants access, as in step 709, to the requesting client 601.

By treating each of the individual policy implementation applications as steps that should be performed to enable level of access, the system 100 provides consistent level of enforcement across all of the policies. Since the policies are defined outside of the individual implementation applications, it is straightforward to view the entire policy profile for a user or a class of users. The system 101 also provides a high degree of flexibility in that the system 101 can operate with any collection of implementation applications, and can provide different levels of access to different machines based on role, temporal issues (e.g., having the correct virus definitions or whether the machine has recently been connected to another potentially insecure network) or any other factor that an implementation application can measure. Use of an access policy server, in an exemplary embodiment, can reduce cost for the organization, in that such an implementation reduces the amount of interaction and “special case” work required by network managers. Furthermore, the described arrangement provides a workable platform for the sharing of policy information. Since the enforcement applications can be trusted network infrastructure elements, a simple description language and transport mechanism (e.g., DNS) could be used to reliably vouch for the security posture of a machine on either end of a conversation.

The above described processes relating to access control may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

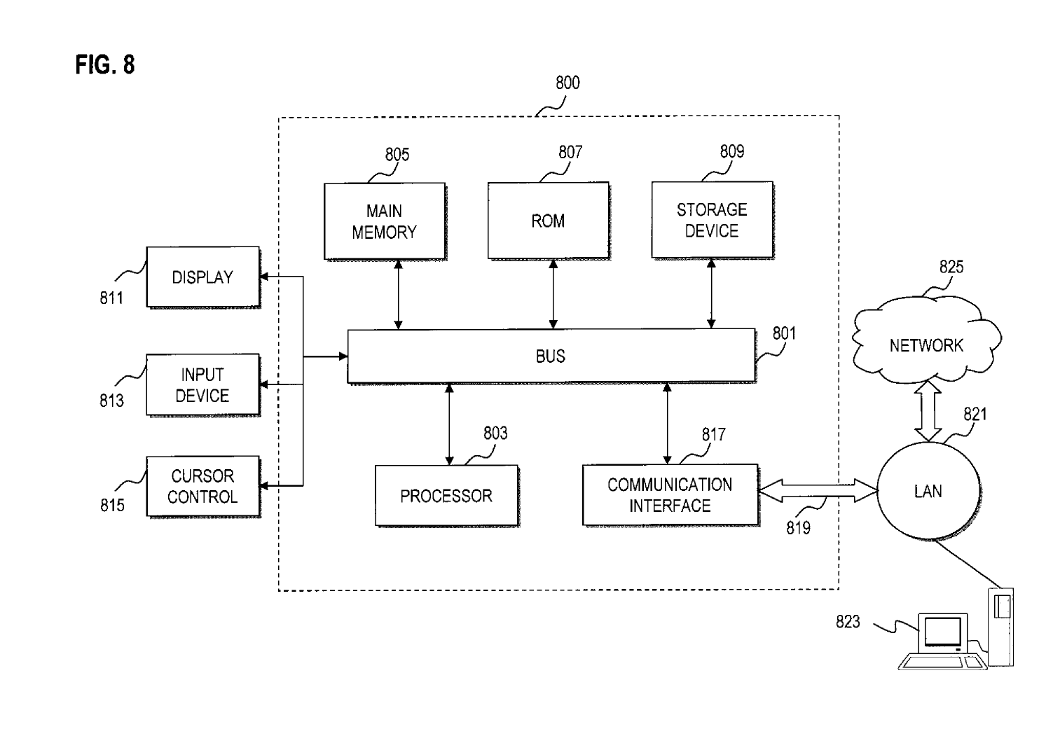

FIG. 8 illustrates a computer system 800 upon which an embodiment according to the present invention can be implemented. For example, the processes described herein can be implemented using the computer system 800. The computer system 800 includes a bus 801 or other communication mechanism for communicating information and a processor 803 coupled to the bus 801 for processing information. The computer system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for controlling cursor movement on the display 811.

According to one embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the present invention. Thus, embodiments of the present invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Model (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the present invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to nonvolatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that flow. The specification and the drawings are accordingly to be regarded in an illustrative rather than restrictive sense.

What is claimed is:

1. A method comprising:
receiving a metric corresponding to a policy for accessing a resource within a network;
updating rating of a user based on the received metric; and
granting an access level for accessing the resource to the user based on the rating.

2. A method according to claim 1, further comprising:
dynamically configuring a network device of the network according to the granted access level.

3. A method according to claim 2, wherein the metric is specified within a voucher that is generated by an application operating within the network.

4. A method according to claim 3, wherein the application is configured to measure an activity and to automatically generate the voucher in response to the measured activity.

5. A method according to claim 3, wherein the voucher is transmitted according to a Domain Name System (DNS) protocol.

6. A method according to claim 1, wherein the metric represents degree of compliance with the policy.

7. An apparatus comprising:
a controller configured to receive a metric corresponding to a policy for accessing a resource within a network; and
an access rating module configured to update rating of a user based on the received metric, wherein an access level is granted for accessing the resource to the user based on the rating.

8. An apparatus according to claim 7, wherein the controller is further configured to dynamically configure a network device of the network according to the granted access level.

9. An apparatus according to claim 8, wherein the metric is specified within a voucher that is generated by an application operating within the network.

10. An apparatus according to claim 9, wherein the application is configured to measure an activity and to automatically generate the voucher in response to the measured activity.

11. An apparatus according to claim 9, wherein the voucher is transmitted according to a Domain Name System (DNS) protocol.

12. An apparatus according to claim 7, wherein the metric represents degree of compliance with the policy.

13. A method comprising:
measuring an activity relating to a policy of a network;
generating a voucher including information about the measured activity; and
transmitting the voucher to a policy enforcement system that is configured to grant an access level to the network based on a rating that is generated based on the voucher.

14. A method according to claim 13, wherein the policy enforcement system is further configured to dynamically configure a network device of the network according to the granted access level.

15. A method according to claim 13, wherein the voucher is transmitted according to a Domain Name System (DNS) protocol.

16. A method according to claim 13, wherein the voucher indicates compliance with the policy.

17. An apparatus comprising:
a process configured to execute an application capable of measuring an activity relating to a policy of a network, and to generate a voucher including information about the measured activity; and
a communication interface configured to transmit the voucher to a policy enforcement system that is configured to grant an access level to the network based on a rating that is generated based on the voucher.

18. An apparatus according to claim 17, wherein the policy enforcement system is further configured to dynamically configure a network device of the network according to the granted access level.

19. An apparatus according to claim 17, wherein the voucher is transmitted according to a Domain Name System (DNS) protocol.

20. An apparatus according to claim 17, wherein the voucher indicates compliance with the policy.

21. A system comprising:
a voucher collector configured to store a plurality of vouchers generated by a plurality of assurance tools, each of the vouchers providing information relating to compliance with a network policy;
a policy engine configured to store the network policy;
an access rating module configured to update rating of a user based on one of the corresponding vouchers; and
granting an access level for accessing the resource to the user based on the rating.

22. A system according to claim 21, further comprising:
a controller configured to dynamically configure a network device of a network according to the granted access level.
